(19) United States
(12) Patent Application Publication
(10) Pub. No.: US 2026/0317068 A1
(43) Pub. Date: Oct. 15, 2026

(54) Conveying Device with Accumulation Roller Chain Running in a Base Body Closed by an Auxiliary Body

(71) Applicant: Robert Bosch GmbH, Stuttgart (DE)

(72) Inventor: Markus Kiebel, Stuttgart (DE)

(21) Appl. No.: 19/646,236

(22) Filed: Apr. 13, 2026

(30) Foreign Application Priority Data
Apr. 14, 2025 (DE) 10 2025 114 565.2

(51) Int. Cl. B65G 17/24; B65G 17/34

(52) U.S. Cl. CPC B65G 17/24; B65G 17/34

(57) ABSTRACT

A conveying device has at least one integral base body, each of which is associated with an endless accumulation roller chain. The accumulation roller chain forms a first, second and third row of rollers. The first row of rollers is supported on an associated first sliding bar, and the third row of rollers is supported on an associated second sliding bar. The aforementioned cross-sectional shape of a base body forms a respective L-shaped first leg which covers the respective associated first row of rollers. A free end of the first leg of the second row of rollers is spaced apart in the transverse direction. At least one base body is associated with a separate auxiliary body which extends with a constant cross-sectional shape along the conveying direction. The auxiliary body is fastened to the respective base body. The auxiliary body forms an L-shaped second leg which covers the third row of rollers. A free end of the second leg of the second row of rollers is spaced apart in the transverse direction. The second row of rollers protrudes in the vertical direction above the second leg.

This application claims priority under 35 U.S.C. § 119 to application no. DE 10 2025 114 565.2, filed on Apr. 14, 2025 in Germany, the disclosure of which is incorporated herein by reference in its entirety.

### BACKGROUND

The disclosure relates to a conveying device according to the description and drawings set forth below.

A conveying device with an accumulation roller chain is known from EP 3 896 011 B1. The accumulation roller chain runs in an integral base body made of aluminum in the extrusion process. The base body has a first and a second leg, each of which is L-shaped, covering a respective associated first or third row of rollers of the accumulation roller chain. The conveyed material is carried by a second row of rollers which protrude in a vertical direction above the first and second legs. A separate first sliding bar is fastened to the base body, on which the first row of rollers runs, wherein a separate second sliding bar is fastened to the base body, on which the third row of rollers runs.

With the present disclosure, a conveying device is to be created that is suitable for particularly heavy conveyed material. In particular, line loads of up to 3 kg per cm of conveying device section are to be enabled. The known plastic sliding bars are no longer sufficient for this purpose. Therefore, preferably sliding bars made of steel are used that have a significantly higher carrying capacity. However, these sliding bars are hardly flexible. They can therefore no longer be mounted by the narrow gap in the known base body through which the second row of rollers projects out of the base body. In particular, this problem is to be solved with the present disclosure.

### SUMMARY

According to the disclosure, it is proposed that the at least one base body is associated with a separate auxiliary body which extends with a constant cross-sectional shape along the conveying direction, wherein the auxiliary body is fastened to the respective base body, wherein the auxiliary body forms an L-shaped second leg which covers the third row of rollers, wherein a free end of the second leg of the second row of rollers is spaced apart in the transverse direction, wherein the second row of rollers protrudes in the vertical direction above the second leg. The first and second sliding bars are preferably mounted before the auxiliary body is fastened to the base body. The mounting location of the first and second sliding bars is thus easily accessible. The base body and/or the auxiliary body are preferably made of aluminum, wherein they are most preferably manufactured in the extrusion process. The first and/or the second sliding bar are preferably pressed into the base body.

Advantageous developments and improvements of the disclosure are also set forth below.

It may be provided that the first and/or the second sliding bar are each made of a stainless steel. Such sliding bars can carry very high loads so that the conveying device can convey particularly heavy material. However, due to their low elasticity, they are difficult to mount in the known integral base body. The stainless steel preferably has an austenitic microstructure, which is most preferably the material X5CrNi18-10 (corresponding to material number 1.4301).

It may be provided that the auxiliary body comprises a plate-type fastening portion, which is aligned parallel to the vertical direction, wherein a free support end of the fastening portion facing the base body abuts the base body in the vertical direction, wherein a plurality of separate gripping bodies are provided, which are distributed along the conveying direction and are fastened to the base body, wherein the gripping bodies each have a hook-like gripping portion which engages behind a gripping end of the fastening portion, wherein the gripping end is opposite the support end in the vertical direction. The corresponding auxiliary body requires particularly little material and can thus be manufactured inexpensively. It is still securely fastened to the base body. The gripping bodies are preferably designed to be identical to each other. They are preferably of constant width in the conveying direction. Their length in the vertical direction is preferably greater, preferably at least 5 times greater, than the said width.

It may be provided that the fastening portion abuts a flat support surface of the respective base body, wherein the support surface is aligned perpendicular to the transverse direction. The fastening portion is thus arranged between the support surface and the gripping bodies so that it is secured against displacement in the transverse direction.

It may be provided that the support end forms a corner in the area of the support surface including an angle of less than 80°. This corner causes the fastening portion to be pressed against the support surface solely by a force acting in the vertical direction, which is exerted by the gripping body. The auxiliary body is subsequently fastened to the base body in without play. The corresponding corner is preferably defined by two flat surfaces of the auxiliary body, which are aligned parallel to the conveying direction.

It may be provided that the gripping body has a clamping surface which abuts both the base body and the fastening portion, wherein the gripping end forms a corner in the area of the clamping surface, which includes an angle of less than 80°. This corner causes the fastening portion to be pressed against the clamping surface solely by a force acting in the vertical direction, which is exerted by the gripping body. The engagement between the gripping body and the auxiliary body is consequently free of play. The clamping surface preferably directly abuts the base body and/or the fastening portion. The clamping surface is preferably flat, wherein it is most preferable that the corresponding counter surfaces on the base body and on the auxiliary body are also flat. The gripping portion of the gripping body is preferably adapted to the said corner. The corresponding corner is preferably defined by two flat surfaces of the auxiliary body, which are aligned parallel to the conveying direction.

It can be provided that the base body comprises at least one undercut groove, wherein the gripping bodies are screwed to a respective assigned undercut groove. This fastening of the gripping bodies is very stable and yet inexpensive. Preferably, the aforementioned bolting occurs with a groove nut, a hammer nut or a hammer screw, which engages the undercut groove in each case. The undercut groove is preferably T-shaped when viewed in cross-section.

It may be provided that a separate third sliding bar is fastened to at least one auxiliary body, which forms a side guide for the conveyed material. The side guide is therefore not arranged on the base body. The comparatively large and thus expensive base body can consequently also be used in the transverse center of the conveying device, i.e. at a location where no side guide is required, whereby the corresponding geometry would actually interfere with the movement of the conveyed material. The third sliding bar is preferably made of steel, most preferably stainless steel, and in particular made of the same material as the first and second sliding bars. It is contemplated that the third sliding bar will be made of plastic.

It can be provided that the third sliding bar has a U-shaped cross-section, wherein it surrounds a retaining extension on the auxiliary body facing in the vertical direction. Such a side guide is particularly stable so that it can be used with very heavy conveyed material.

It may be provided that the first and/or the second sliding bar are each L-shaped when viewed in cross-section. This cross-sectional shape is easier to manufacture for a sliding bar made of steel than the known T-shape made of plastic. It can nevertheless be pressed into the base body in a comparable manner.

It may be provided that the at least one base body comprises a first and a second base body, which are configured in a mirror symmetrical manner relative to a plane that is perpendicular to the transverse direction such that the respective second row of rollers define a conveying plane that is perpendicular to the vertical direction. Since the base body extends with a constant cross-sectional shape in the conveying direction, the aforementioned mirror symmetry can be brought about by turning the base body by 180°, wherein the corresponding turning axis is aligned parallel to the vertical direction. The first and second base bodies can thus be manufactured with the same extrusion tool. The situation is analogous for the respective auxiliary bodies.

It may be provided that the auxiliary bodies of the first and second base bodies are arranged in relation to the transverse direction on a side of the respective first or second base body facing away from the other, second or first, base body, wherein a separate third plastic sliding bar is fastened to each of the aforementioned auxiliary bodies, which forms a side guide for the conveyed material. The conveyed material is thus guided in the transverse direction on both opposite sides.

It can be provided that the at least one base body comprises at least one third base body arranged in the transverse direction between the first and the second base body, wherein the respective second row of rollers protrudes in the vertical direction above the respective auxiliary body. With such a conveying device, particularly heavy conveyed material can be transported. The auxiliary body of the third base body is in particular not associated with a third sliding bar and a corresponding retaining extension. Preferably, the second row of rollers of the third base body tangentially contacts the conveying plane.

Of course, the above-mentioned features and those to be explained below can be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The figure shows:

FIG. 1 a perspective view of a part of a conveying device according to the disclosure; and

FIG. 2 a cross-section of the first or the second base body of the conveying device according to FIG. 1.

### DETAILED DESCRIPTION

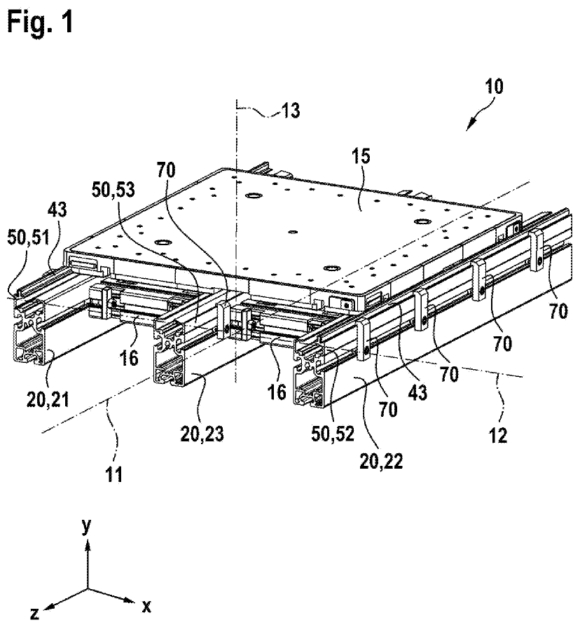

FIG. 1 shows a perspective view of a part of a conveying device 10 according to the disclosure. In the present case, the conveying device 10 comprises three base bodies 20, namely a first base body 21, a second base body 22 and a third base body 23. All base bodies 20 extend with the same cross-sectional shape along the conveying direction 11. It is noted here that the first base body 21 is installed rotated by 180° relative to a turning axis with respect to the second base body 22, so that the first base body 21 and the second base body 22 effectively have a mirror-symmetrical cross-sectional shape. The aforementioned turning axis is aligned parallel to the vertical direction 13. A transverse direction 12 is aligned perpendicular to the conveying direction 11, wherein the vertical direction 13 is aligned perpendicular to the conveying direction 11 and the transverse direction 12.

The identical cross-sectional shape of the base body 20 is due to the fact that all the base bodies 20 are made of aluminum in the extrusion process, wherein the same extrusion tool is used for all base bodies 20.

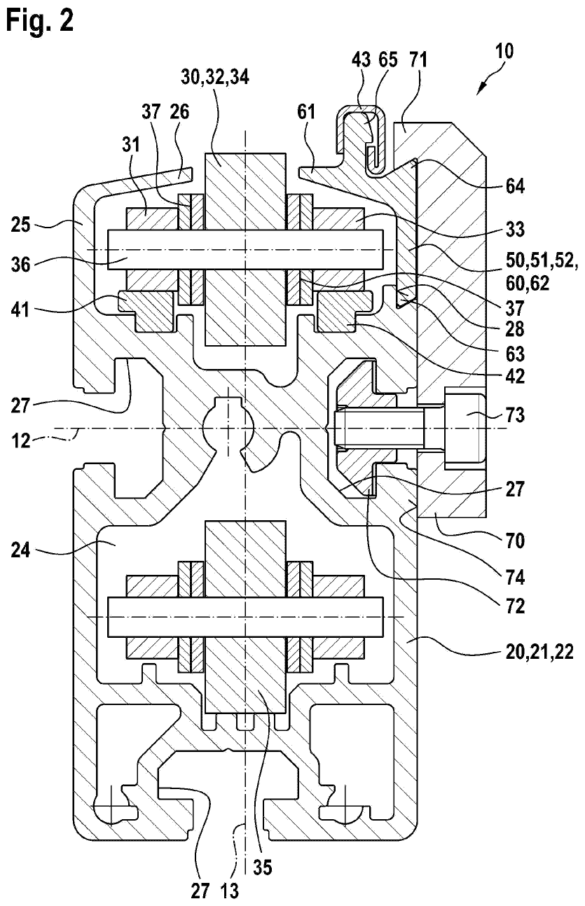

In the present case, the various base bodies 20 are fixedly connected to each other via connection struts 16. The connection struts 16 are each configured in the form of a T-slot profile made of aluminum, which extends parallel to the transverse direction 12. They are screwed to the base body 20 on both opposite front ends with a corresponding undercut groove (no. 27 in FIG. 2).

In each base body 20, an accumulation roller chain (#30 in FIG. 2) is received in sections (not shown in FIG. 1). The accumulation roller chain runs continuously in the conveying device 10, resulting in a leading strand (no. 34 in FIG. 2) and a trailing strand (no. 35 in FIG. 2). In FIG. 1, only the part of the conveying device 10 is shown in which the accumulation roller chain is parallel to the conveying direction 11. For example, a deflection usable in the context of the present disclosure for an accumulation roller chain is shown in EP 1 188 694 B1.

The leading strand of the accumulation roller chain supports the conveyed material 15, which in the present case is formed by a plate-like workpiece carrier. The present workpiece carrier has a rectangular, preferably square, outline. The second rows of rollers (no. 32 in FIG. 2) of the present three accumulation roller chains abut the conveyed material 15. It should be understood that even more accumulation roller chains are usable to support a particularly heavy conveyed material 15. The respective rollers preferably tangentially contact a common conveying plane, wherein the conveying plane is aligned perpendicular to the vertical direction 13. Accordingly, the plate-like workpiece carrier is also aligned perpendicular to the vertical direction 13.

It should also be noted that there are two side guides for the conveyed material 15, located opposite each other in the transverse direction 12. These are each formed by a third sliding bar 43, which is fastened to a first auxiliary body 51 or a second auxiliary body 52. The first auxiliary body 51 is in turn fastened to the first base body 21, wherein the second auxiliary body 52 is fastened to the second base body 22. In both cases, a plurality of gripping bodies 70 is used for this purpose, which are distributed along the conveying direction 11.

The middle, third base body 23 is associated with a third auxiliary body 53, which is fastened to the third base body 23 in an analogous manner. With the third auxiliary body 53, however, the third sliding bar 43 and the associated retaining extension (no. 65 in FIG. 2) were omitted. An advantage of the disclosure is that in a three-lane conveying device 10, the same base body 20 can be used for all three tracks, wherein only the middle third track requires a different auxiliary body 53 than the two outer tracks. The third base body 23 can be installed in the position shown or be installed 180° around the aforementioned turning axis.

FIG. 2 shows a cross-section of the first base body 21 or the second base body 22 of the conveying device 10 according to FIG. 1. The section plane is aligned perpendicular to the conveying direction. In FIG. 1, the already addressed accumulation roller chain 30 can first be seen with its leading strand 34 and its return strand 35. The accumulation roller chain 30 comprises a first row of rollers 31, a second row of rollers 32, and a third row of rollers 33 arranged adjacent to each other in the specified order in the transverse direction 12. The respective rollers are supported by bolts 36 extending in the transverse direction 12. Bolts 36 adjacent each other in the conveying direction are connected to each other via tabs 37 in an articulated manner. A tab 37 is arranged between the first row of rollers 31 and the second row of rollers 32, wherein a further tab 37 is arranged between the second row of rollers 32 and the third row of rollers 33. The accumulation roller chain 30 can be embodied in accordance with DE 10 2018 116 672 A1, for example.

The rollers of the first row of rollers 31 and the third row of rollers 33 are each of the same diameter, which is smaller than the diameter of the rollers of the second row of rollers 32. The first row of rollers 31 runs on a separate first sliding bar 41, wherein the third row of rollers 33 runs on a separate second sliding bar 42. The conveyed material is in turn supported on the second row of rollers 32. The weight of the conveyed material is thus supported on the first sliding bar 41 and the second sliding bar 42 via the accumulation roller chain 30.

The conveying device 10 according to the disclosure is provided for particularly heavy conveyed material, which, for example, can have a line load of up to 3 kg per cm of conveying section. In particular, battery modules for an electrically driven vehicle can be considered as the conveyed material. Due to the high line load, the first sliding bar 41 and the second sliding bar 42 are preferably made of steel, most preferably stainless steel, in particular X5CrNi18-10 (corresponding to material number 1.4301). They preferably have an L-shaped cross-sectional shape, wherein one horizontal leg supports the associated first row of rollers 31 or third row of rollers 33, the other vertical leg being pressed into an adjusted recess in the base body 20. The horizontal leg is supported in the vertical direction 13 directly on the base body 20. Such sliding bars 41, 42 have a very high stiffness. However, the assembly of sliding bars 41, 42 on a base body 20, which comprises two integral legs 25, 60 for covering the first row of rollers 31 and third row of rollers 33 (see EP 3 896 011 B1), requires that the sliding bars 41, 42 be significantly bent during assembly. This is easily possible with plastic sliding bars, but not with the preferred very stiff steel sliding bars 41, 42. In the context of the present application, vertical is to be understood to mean running in the vertical direction 13, wherein horizontal is to be understood to mean running in the transverse direction 12.

The base body 20 extends along the conveying direction with the constant cross-sectional shape shown in FIG. 2. In the present case, the cross-sectional shape forms three undercut grooves 27, each of which are T-shaped when viewed in cross-section, so that they can receive a hammer nut 72, a groove nut or a hammer screw. The cross-sectional shape of the base body 20 continuously encloses a cavity 24 in which the return strand 35 of the accumulation roller chain 30 runs. No sliding bar can be mounted there, which is why the second row of rollers 32 runs there directly on the base body 20, wherein the first row of rollers 31 and the third row of rollers 33 are arranged at a distance from the base body 20. In the present case, the second row of rollers 32 of the return strand 35 extends onto the base body 20 on two extensions extending in the vertical direction 13. As a result, excess oil can collect in the interstices, which are arranged adjacent to the aforementioned extensions. Carryover of excess oil by the accumulation roller chain 30 is thus avoided.

The integral base body 20 further forms a first leg 25, which is L-shaped and which covers the first row of rollers 31 such that a free end 26 of the first leg 25 is arranged in the transverse direction 12 with a small distance to the second row of rollers 32, wherein the second row of rollers 32 protrudes in the vertical direction 13 above the first leg 25. The aforementioned free end 26 is formed by the section running at least approximately parallel to the transverse direction 12, wherein a section of the first leg 25 running in the vertical direction 13 is integrally connected to the rest of the base body 20. On the opposite side in the transverse direction 12, the base body 20 is designed to be open when viewed on its own. From there, the first sliding bar 41 and the second sliding bar 42 can therefore be inserted or pressed into the base body 20 without having to bend them for this purpose. Only thereafter is the accumulation roller chain 30 installed, and subsequently the auxiliary body 50 is mounted, which forms the second leg 60.

The L-shaped second leg 60 is configured analogously to the first leg 25. Its free end 61 therefore also faces the second row of rollers 32 in the transverse direction 12 with a short distance. It covers the third row of rollers 33. The second row of rollers 32 is in the vertical direction 13 above the second leg 60. The second leg 60 is formed from a separate auxiliary body 50, which is preferably made from aluminum in the extrusion process. The auxiliary body 50 therefore extends along the conveying direction with the constant cross-sectional shape seen in FIG. 2.

The auxiliary body 50 is designed to be as cost-effectively produced as possible, in particular with its cross-sectional area being minimized. Subsequently, only a few attachment points result for fastening the auxiliary body 50 to the base body 20. Nevertheless, the fastening must be stable as at least a part of the auxiliary body 50 preferably forms a side guide for the conveyed material. For this purpose, the U-shaped third sliding bar 43 is provided, which is snapped onto a retaining extension 65 of the auxiliary body 50 pointing in the vertical direction 13. The third sliding bar 43 is preferably made of plastic. For example, the third sliding bar 43 and the associated retaining extension 65 may be configured according to any one of the embodiments of EP 1 273 536 B1.

The fastening of the auxiliary body 50 to the base body 20 is carried out by way of a plurality of separate gripping bodies 70, which are fastened to the base body 20 in a distributed manner along the conveying direction 11, namely to a respectively assigned undercut groove 27. In the present case, a hammer nut 72 is inserted into the respective undercut groove 27, in which a screw 73 is screwed into, which penetrates the gripping body 70. In the present case, the screw 73 is configured as a cylinder head screw, the head of which is recessed in a countersink of the gripping body 70. The gripping body 70 has a flat clamping surface 74, which directly abuts a flat counter surface on the base body 20. The aforementioned flat surfaces are aligned perpendicular to the transverse direction 12. This connection is very stable so that the gripping body 70 can easily transfer the forces caused by the side guide of the conveyed material 15 to the base body 20. Each gripping body 70 preferably has a constant width in the conveying direction, extending parallel to the vertical direction 13.

The auxiliary body 50 forms a plate-like fastening portion 62 which, with its preferably flat outer side, abuts directly against the clamping surface 74 of gripping body 70. When viewed in the vertical direction 13, the fastening portion 62 has a support end 63 and an opposite gripping end 64, both of which form a corner. The two corners each include an angle of less than 80°, in particular an angle of 60°. The aforementioned corners are preferably rounded to a small radius so that they can be produced in the extrusion process. The two corners are arranged diagonally opposite on the fastening portion 62. The fastening portion 62 is thus pressed against the gripping body 70 at the gripping end 64 by the rear grip of the gripping portion 71 of the gripping body 70 located there. At the opposing support end 63, the fastening portion 62 is pressed against the base body 20. It should be noted here that the base body 20 is adapted to the corner at the support end 63. In particular, it has a flat support surface 28 arranged perpendicular to the transverse direction 12, which abuts laterally on the inside of the fastening portion 62. Thus, the fastening portion 62 has two defined clamping points that have a maximum distance given the minimum size of the auxiliary body 50. The fastening of the auxiliary body 50 is thus particularly stable.

### REFERENCE SIGNS

10 Conveying device
11 Conveying direction
12 Transverse direction
13 Vertical direction
15 Conveyed material
16 Connecting strut
20 Base body
21 First base body
22 Second base body
23 Third base body
24 Cavity
25 First leg
26 Free end of first leg
27 Undercut groove
28 Support surface
30 Accumulation roller chain
31 First row of rollers
32 Second row of rollers
33 Third row of rollers
34 Leading strand
35 Return strand
36 Bolt
37 Tab
41 First sliding bar
42 Second sliding bar
43 Third sliding bar
50 Auxiliary body
51 First auxiliary body
52 Second auxiliary body
53 Third auxiliary body
60 Second leg
61 Free end of second leg
62 Fastening portion
63 Support end
64 Gripping end
65 Retaining extension
70 Gripping body
71 Gripping portion
72 Hammer nut
73 Screw
74 Clamping surface

What is claimed is:

1. A conveying device, comprising:
at least one integral base body that extends with a constant cross-sectional shape along a conveying direction;
an endless accumulation roller chain associated with the base body, wherein the endless accumulation roller chain has a leading strand and a trailing strand;
a separate auxiliary body associated with the base body; and
a separate first and a separate second sliding bar each associated with the base body,
wherein the endless accumulation roller chain forms a first, second and third row of rollers which are arranged next to one another along a transverse direction in the order indicated,
wherein the transverse direction is aligned perpendicular to the conveying direction,
wherein the rollers of the second row of rollers have a larger diameter than the rollers of the first and third rows of rollers,
wherein the trailing strand is arranged in a closed cavity of the respective base body,
wherein the first and second sliding bars are each fastened to the respective base body,
wherein the first row of rollers is supported on the associated first sliding bar,
wherein the third row of rollers is supported on the associated second sliding bar,
wherein the cross-sectional shape of the base body forms in each case an L-shaped first leg which covers the associated first row of rollers in each case,
wherein a free end of the first leg of the second row of rollers is spaced apart in the transverse direction,
wherein the second row of rollers protrudes in a vertical direction above the respective first leg such that a conveyed material is supported on the second row of rollers,
wherein the vertical direction is aligned perpendicular to the conveying direction and the transverse direction,
wherein the auxiliary body extends with a constant cross-sectional shape along the conveying direction,
wherein the auxiliary body is fastened to the respective base body,
wherein the auxiliary body forms an L-shaped second leg which covers the third row of rollers, with a free end of the second leg of the second row of rollers facing spaced apart in the transverse direction, and
wherein the second row of rollers protrudes in the vertical direction above the second leg.

2. The conveying device according to claim 1, wherein the first and/or the second sliding bar are each made of stainless steel.

3. The conveying device according to claim 1, further comprising a plurality of separate gripping bodies, wherein:
the auxiliary body comprises a plate-type fastening portion which is aligned parallel to the vertical direction,
a free support end of the fastening portion facing the base body abuts the base body in the vertical direction,
the plurality of separate gripping bodies are distributed along the conveying direction and fastened to the base body,
the gripping bodies each have a hook-like gripping portion which engages behind a gripping end of the fastening portion, and
the gripping end is opposite the support end in the vertical direction.

4. The conveying device according to claim 3, wherein the fastening portion abuts a flat support surface of the base body in question, and wherein the support surface is aligned perpendicular to the transverse direction.

5. The conveying device according to claim 4, wherein the support end is configured to form a corner in the area of the support surface including an angle of less than 80°.

6. The conveying device according to claim 3, wherein the gripping body has a clamping surface which abuts both the base body and the fastening portion, and wherein the gripping end is configured to form a corner in the area of the clamping surface which includes an angle of less than 80°.

7. The conveying device according to claim 1, wherein the base body comprises at least one undercut groove, and wherein the gripping bodies are screwed to a respective associated undercut groove.

8. The conveying device according to claim 1, wherein a separate third sliding bar is fastened to at least one auxiliary body which forms a side guide for the conveyed material.

9. The conveying device according to claim 8, wherein the third sliding bar has a U-shaped cross-section, and wherein it surrounds a retaining extension on the auxiliary body pointing in the vertical direction.

10. The conveying device according to claim 1, wherein the first and/or the second sliding bar are each L-shaped when viewed in cross section.

11. The conveying device according to claim 1, wherein the base body comprises a first and a second base body which are configured in a mirror-symmetrical manner relative to a plane that is perpendicular to the transverse axis, such that the respective second rows of rollers define a conveying plane that is perpendicular to the vertical direction.

12. The conveying device according to claim 11, wherein:
the auxiliary bodies of the first and the second base bodies are arranged relative to the transverse direction on a side of the other, second or first, base body of the respective first or second base body,
a separate third sliding bar is fastened to at least one auxiliary body which forms a side guide for the conveyed material, and
the third sliding bar has a U-shaped cross-section, and wherein it surrounds a retaining extension on the auxiliary body pointing in the vertical direction.

13. The conveying device according to claim 11, wherein the base body comprises at least one third base body arranged in the transverse direction between the first and the second base body, and wherein the respective second row of rollers protrudes in the vertical direction above the respective auxiliary body.
